(19) United States
(12) Patent Application Publication
(10) Pub. No.: US 2013/0290602 A1
(43) Pub. Date: Oct. 31, 2013

(54) DATA STORAGE DEVICE

(71) Applicant: Ming-Ju Chu, Taipei City (TW)

(72) Inventor: Ming-Ju Chu, Taipei City (TW)

(21) Appl. No.: 13/457,498

(22) Filed: Apr. 27, 2012

(51) Int. Cl. G06F 12/00; G06F 12/14

(52) U.S. Cl. 711/103; 711/154; 711/E12.092; 711/E12.008

(57) ABSTRACT

A data storage device includes a memory, a controller, a first module, a first interface, and a second interface. The first interface and the second interface are coupled to the controller. The controller is used to access data in the memory, the first module is used to perform a first predetermined function. The second interface is inaccessible to the first module. The first interface may gain access to at least one additional module in the data storage device to perform at least one additional predetermined function which the second interface may not gain access to and may not perform.

### BACKGROUND

1. Technical Field

The present invention relates to a data storage device, more particularly, a data storage device with more than one interface.

2. Description of the Conventional Art

Data storage devices such as SD (Secure Digital) card, SSD (Solid State Drive) , Portable USB Flash Memory Device, and so on are used in daily lives extensively for storing data of various digital devices. These data storage devices come with advantages of small in size, abundance in storage capacity, and standard interfaces, etc.

For example, most digital cameras require SD cards or other data storage devices to store image data taken by digital cameras. Once the image data has been stored in these data storage devices, the data can be transferred to other digital devices such as computers for later use.

Usually, function of data storage devices is limited to as being able to be written or read by digital devices, and only one interface is disposed on each data storage device. However, as technology advances, it becomes necessary to integrate more diverse functions into one single data storage device for enabling the data storage device to perform more diverse functions instead of a single function.

### SUMMARY

An embodiment of the present invention discloses a data storage device. The data storage device comprises a memory, a controller, a first module, a first interface, and a second interface. The controller is used to access data in the memory. The first module is used to perform a first predetermined function. The first interface and the second interface are coupled to the controller. The second interface is inaccessible to the first module and vice verse.

An embodiment of the present invention discloses a data storage device operating method. The data storage device comprises a first interface and a second interface. The method comprises selectively connecting the data storage device to a host device through the first interface or the second interface of the data storage device, performing a first predetermine function when the first interface is connected to the host device, and performing a second predetermine function when the second interface is connected to the host device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a data storage device according to an embodiment of the present invention.

FIG. 2 is a block diagram of an embodiment of the data storage device in FIG. 1.

FIG. 3 is a block diagram of an embodiment of the data storage device in FIG. 1.

FIG. 4 is a block diagram illustrating a data storage device according to an embodiment of the present invention.

FIG. 5 is a block diagram of an embodiment of the data storage device in FIG. 4.

FIG. 6 is a block diagram of an embodiment of the data storage device in FIG. 4.

### DETAILED DESCRIPTION

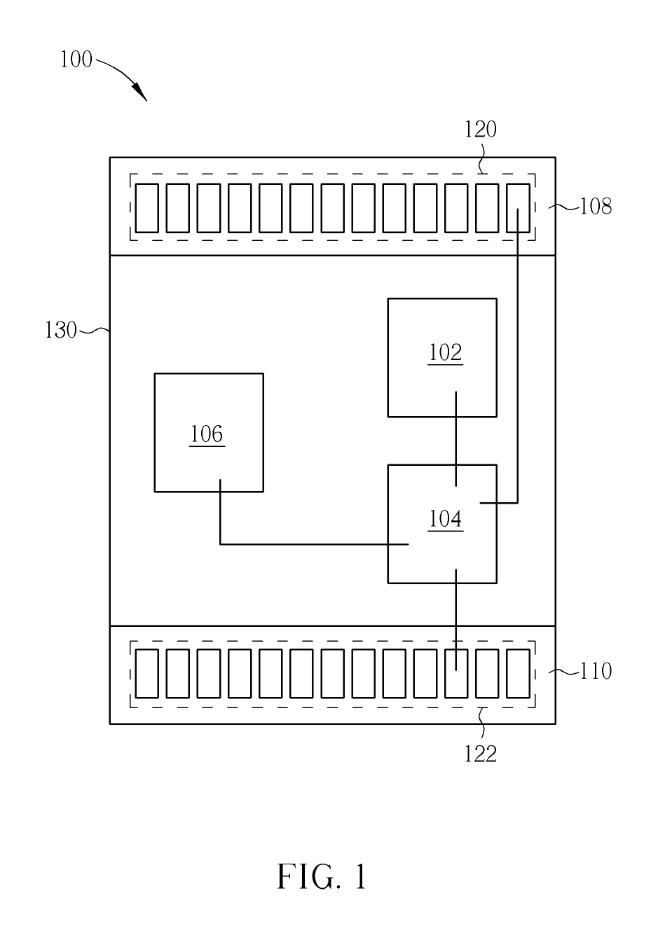

Please refer to FIG. 1. FIG. 1 is a block diagram illustrating a data storage device 100 according to an embodiment of the present invention. The data storage device 100 comprises a main substrate 130, and elements including a memory 102, a controller 104, a first module 106, a first interface 108, and a second interface 110 are disposed thereon. The controller 104 is coupled to the memory 102, the first interface 108, the first module 106, and the second interface 110 are coupled to the controller 104. The controller 104 is used to access data in the memory 102. The first module 106 is used to perform a predetermined function of the data storage device 100. The second interface 110 is inaccessible to the first module 106 and vice verse.

The memory 102 may include a flash memory. The first interface 108 and the second interface 110 may be identical interfaces. That is, the first interface 108 and the second interface 110 are compatible to the same interfaces. For example, both the first interface 108 and the second interface 110 may be selected from a group comprising of MMC (Multi Media Card) interface, SD interface, SATA (Serial Advanced Technology Attachment) interface, USB (Universal Serial Bus) interface, or any other interface of memory product . In one embodiment of the present invention, the first interface 108 and the second interface 110 may be two different types of interfaces. Furthermore, the first interface 108 may include a first set of contacts 120 and the second interface 110 may include a second set of contacts 122. Both the first set of contacts 120 and the second set of contacts 122 are disposed on the main substrate 130. The first set of contacts 120 and the second set of contacts 122 may be disposed at opposite ends of a same side, or at opposite ends of different sides of the main substrate 130. The first interface 108 and the second interface 110 of the data storage device 100 are used to connect to a host device (not shown), such as a personal computer, a digital photo frame, or a digital camera etc., for passing signals provided from the host device to the controller 104.

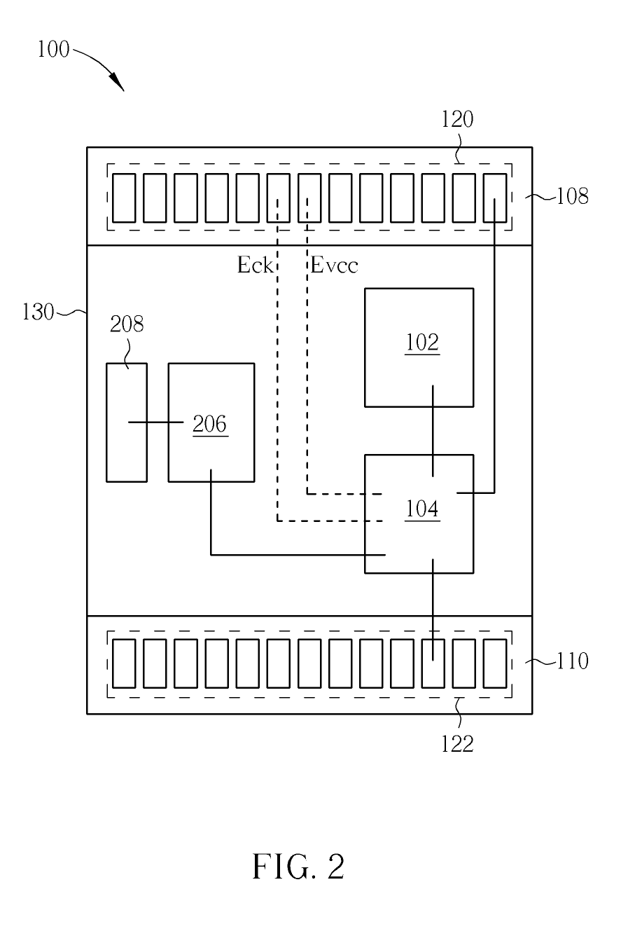

Please refer to FIG. 2. FIG. 2 is a block diagram of an embodiment of the data storage device 100 in FIG. 1 according to the present invention. The first module 106 may include a wireless module 206, and the wireless module 206 can be triggered to enable the predetermined function by receiving a command from the controller 104, wherein the command can only be triggered by signals sent through the first interface 108 to the controller 104. The wireless module 206 may be a conventional wireless connection module, which may be selected from a group comprising of a Bluetooth module, an RF (Radio Frequency) module, a WIFI module, and a WAP (wireless access point) module. And the wireless module 206 may also comprise an antenna 208 combined with the conventional wireless connection module mentioned above. In this embodiment, the predetermined function of the first module 106 is to exchange data wirelessly through the wireless module 206.

When a user connects the data storage device 100 to the host device by the second interface 110, puts the second interface 110 communicating with the host device by contacting physically with an interface of the host device, while the first interface 108 is without physical contact to any interface of the host device. The predetermined function of the wireless module 206 is not enabled because there is no signal passing through the second interface 110 to the controller 104 as shown in FIG. 2 that may instruct the controller 104 providing the command to the wireless module 206. That is, no signal can be sent through the second interface 110 to trigger the command to the wireless module 206. In this embodiment, only the data storage function is enabled in the data storage device 100.

On the contrary, when the user connects the data storage device 100 to the host device by the first interface 108, instead of the second interface 110, puts the first interface 108 communicating with the host device. Signals Evcc and Eck can be sent from the host device through the first interface 108 to instruct the controller 104 to enable the predetermined function of the wireless module 206. Therefore using the first interface 108 as the connecting interface can perform both the data storage function and exchanging data wirelessly through the wireless module 206. In another preferred embodiment of the present invention, one signal would be enough to instruct the controller 104 to enable the predetermined function of the wireless module 206.

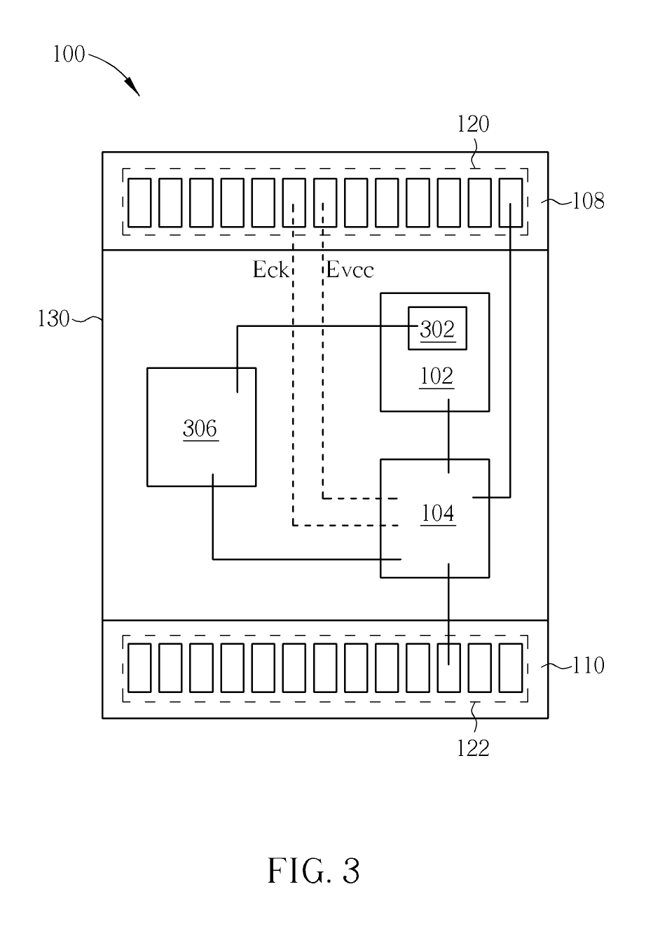

Please refer to FIG. 3. FIG. 3 is a block diagram of another embodiment of the data storage device 100 in FIG. 1 according to the present invention. The first module 106 may be an encryption module 306. In this embodiment, the predetermined function of the first module 106 is used to encrypt data received by the first interface 108 via the encryption module 306. The memory 102 may have an encryption block 302 for storing the data encrypted by the encryption module 306. Besides, the encryption block 302 in the memory 102, along with the encryption module 306, is inaccessible to the second interface 110 and vice verse.

When the user connects the data storage device 100 to the host device by the second interface 110, puts the second interface 110 communicating with the host device. The encryption module 306 is not being accessed and not being enabled because there is no signal passing through the second interface 110 to the controller 104 as shown in FIG. 3 that may instruct the controller 104 providing the command to enable the encryption module 306, That is, no signal can be sent through the second interface 110 to trigger the command to the encryption module 306. Thus, only the data storage function is enabled in the data storage device 100.

On the contrary, when the user connects the data storage device 100 to the host device by the first interface 108, puts the first interface 108, instead of the second interface 110, communicating with the host device. Signals Evcc and Eck can be sent from the host device through the first interface 108 to instruct the controller 104 to enable the encryption module 306. Therefore using the first interface 108 as the connecting interface, the data storage device 100 can perform a data encryption function, that is, the data received by the first interface 108 can be encrypted via the encryption module 306 and then stored in the encryption block 302 in the memory 102. Once the data is stored in the encryption block 302, a decryption procedure must be performed when reading, copying, or modifying the data. And the data can only be accessed through the first interface 108. In another preferred embodiment of the present invention, one signal would be enough to instruct the controller 104 to enable the predetermined function of the encryption module 306.

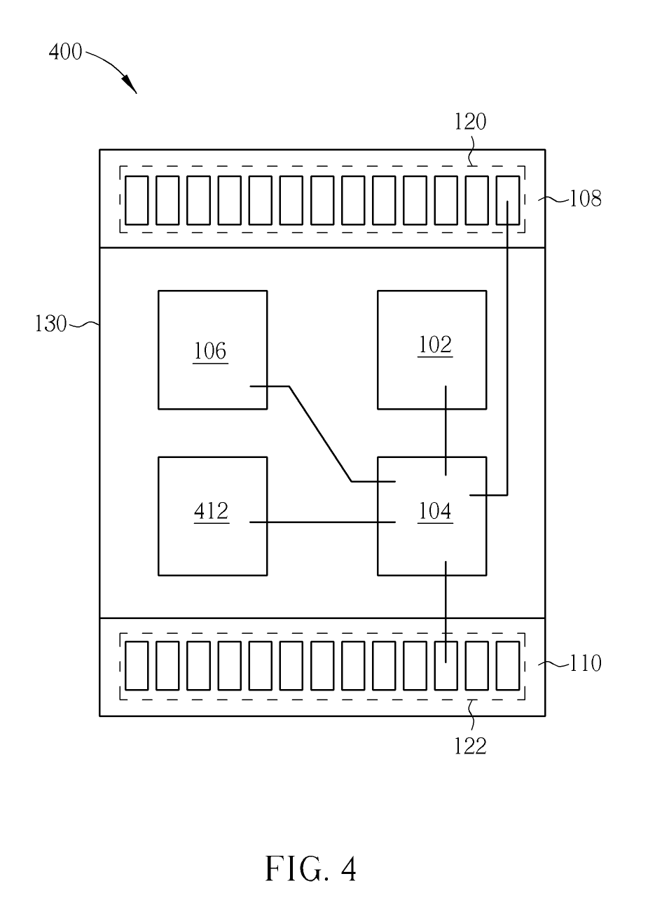

Please refer to FIG. 4. FIG. 4 is a block diagram illustrating a data storage device 400 according to another embodiment of the present invention. The data storage device 400 is the data storage device 100 of FIG. 1 further including a second module 412 coupled to the controller 104 for performing a second predetermined function. The first module 106 of FIG. 4 performs a first predetermined function different from the second predetermined function. Still, the second interface 110 is inaccessible to the first module 106 and vice verse.

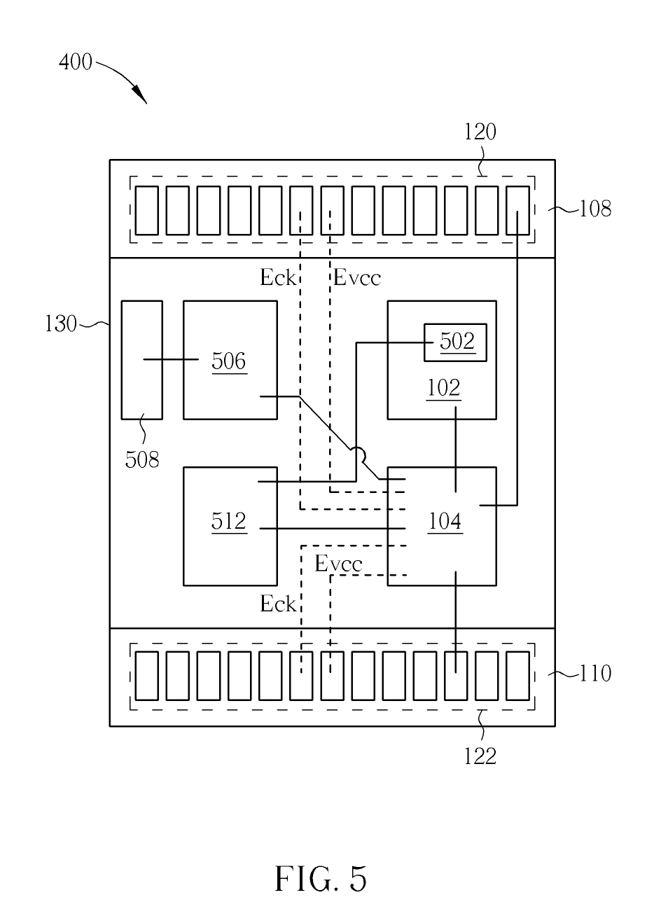

Please refer to FIG. 5. FIG. 5 is a block diagram of an embodiment of the data storage device 400 in FIG. 4 according to the present invention. The first module 106 maybe a wireless module 506, and the wireless module 506 may comprise an antenna 508. The second module 412 may be an encryption module 512. In this embodiment, the first predetermined function of the first module 106 is to exchange digital data wirelessly through the wireless module 506, and the second predetermined function of the second module 412 is to encrypt data received by the first interface 108 and/or the second interface 110 via the encryption module 512. The memory 102 may have an encryption block 502 for storing the data encrypted by the encryption module 512. The wireless module 506 is inaccessible to the second interface 110. The wireless module 506 and the encryption module 512 can be enabled by receiving a first command and a second command from the controller 104.

In one embodiment, when the user connects the data storage device 400 to the host device by the first interface 108, puts the first interface 108 communicating with the host device. Signals Evcc and Eck can be sent from the host device through the first interface 108 to instruct the controller 104 providing the first command to enable the first predetermined function of the wireless module 506. Therefore using the first interface 108 as the connecting interface can perform both the data storage function and exchanging digital data wirelessly through the wireless module 506. In this embodiment, the encryption module 512 and the encryption block 502 in the memory 102 are only accessible to the second interface 110, not the first interface 108.

In another embodiment, when the user connects the data storage device 400 to the host device by the first interface 108, puts the first interface 108 communicating with the host device. Signals Evcc and Eck can be sent from the host device through the first interface 108 to instruct the controller 104 providing the first command to enable both the wireless module 506 and the encryption module 512. Therefore using the first interface 108 as the connecting interface can perform both exchanging digital data wirelessly through the wireless module 506 and the data encryption function (the data received by the first interface 108 can be encrypted via the encryption module 512 and then stored in the encryption block 502 in the memory 102. Once the data is stored in the encryption block 502, the decryption procedure must be performed when reading, copying, or modifying the data). In this embodiment, the encryption module 512 and the encryption block 502 in the memory 102 are or are not accessible to the second interface 110.

On the contrary, when the user connects the data storage device 400 into a digital device by the second interface 110, puts the second interface 110 communicating with the host device. Signals Evcc and Eck can be sent from the host device through the second interface 110 to instruct the controller 104 providing the second command to enable the encryption module 512. The second interface 110 is inaccessible to the wireless module 506 as mentioned above. Therefore using the second interface 110 as the connecting interface can perform the data encryption function (the data received by the second interface 110 can be encrypted via the encryption module 512 and then be stored in the encryption block 502 in the memory 102. Once the data is stored in the encryption block 502, the decryption procedure must be performed when reading, copying, or modifying the data). The data stored in the encryption block 502 may be accessed through the first interface 108 and/or the second interface 110.

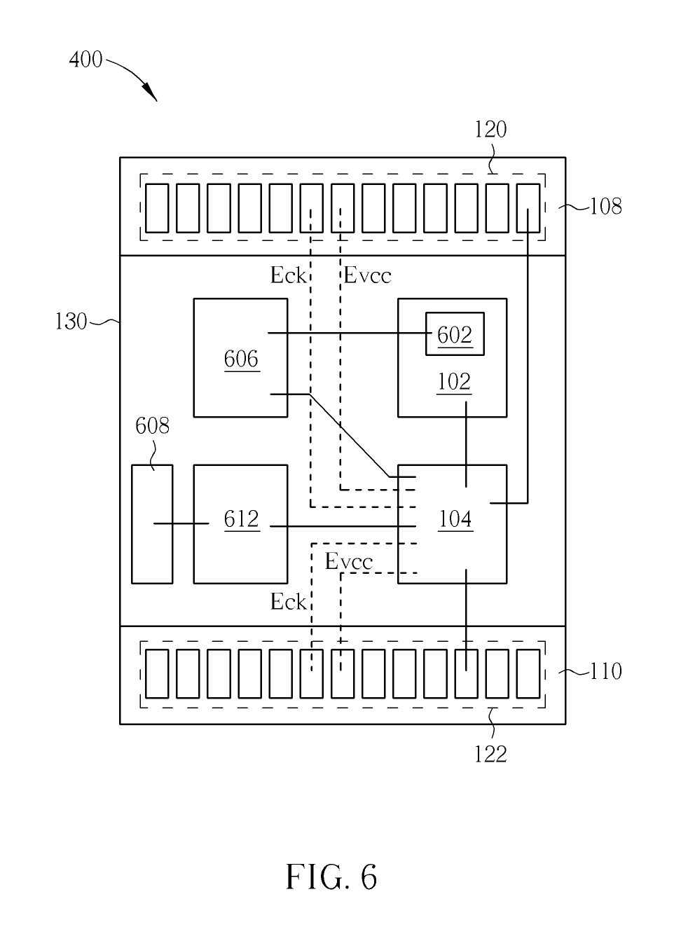

Please refer to FIG. 6. FIG. 6 is a block diagram of another embodiment of the data storage device 400 in FIG. 4 according to the present invention. The first module 106 may be an encryption module 606. The second module 412 may be a wireless module 612, and the wireless module 612 may also comprise an antenna 608. In this embodiment, the first predetermined function of the first module 106 is used to encrypt data received by the first interface 108 via the encryption module 606, and the second predetermined function of the second module 412 is used to exchange digital data wirelessly through the wireless module 612. The memory 102 may have an encryption block 602 for storing data encrypted by the encryption module 606. Besides, the encryption block 602 in the memory 102, along with the encryption module 606, is inaccessible to the second interface 110 and vice verse. The encryption module 606 and the wireless module 612 can be enabled by receiving a first command and a second command from the controller 104. As mentioned above, the provided commands from the controller 104 can be triggered by signals sent from the host device through the first interface 108 or the second interface 110. It should be noticed that in order to enable the first predetermined function and the second predetermined function, such as the encryption module 606 and the wireless module 612, the provided commands may be different for enabling the different predetermined function.

In one embodiment, when the user connects the data storage device 400 into the host device by the first interface 108, puts the first interface 108 communicating with the host device. Signals Evcc and Eck can be sent from the host device through the first interface 108 to instruct the controller 104 providing the first command to enable the first predetermined function of the encryption module 606. Therefore using the first interface 108 as the connecting interface can perform the data encryption function (the data received by the second interface 108 can be encrypted via the encryption module 606 and then stored in the encryption block 602 in the memory 102. Once the data is stored in the encryption block 602, the decryption procedure must be performed when reading, copying, or modifying the data) . In this embodiment, the wireless module 612 is only accessible to the second interface 110, not the first interface 108.

In another embodiment, when the user connects the data storage device 400 into the host device by the first interface 108, puts the first interface 108 communicating with the host device. Signals Evcc and Eck can be sent from the host device through the first interface 108 to instruct the controller 104 providing the first command to enable both the first predetermined function of the encryption module 606 and the second predetermined function of the wireless module 612. Therefore using the first interface 108 as the connecting interface can perform both the data encryption function and exchanging digital data wirelessly through the wireless module 612. In this embodiment, the wireless module 612 is or is not accessible to the second interface 110.

On the contrary, when the user connects the data storage device 400 into a digital device by the second interface 110, puts the second interface 110 communicating with the host device. Signals Evcc and Eck can be sent from the host device through the second interface 110 to instruct the controller 104 providing the second command to enable the wireless module 612. Therefore using the second interface 110 as the connecting interface can perform both the data storage function and exchanging digital data wirelessly through the wireless module 612.

Concluding from embodiments hereinbefore, the user may selectively connects the data storage device 100 to the host device through the first interface 108 or the second interface 110 of the data storage device 100. If the first interface 108 is connected to the host device, the data storage device 100 may perform the first predetermined function. If the second interface 110 is connected to the host device, the data storage device 100 may perform the second predetermined function. Furthermore, the first predetermined function is different from the second predetermined function.

In summary, the present invention is to make the first interface of the data storage device gain access to at least one additional module to perform at least one additional predetermined function which the second interface may not gain access to and perform. When the second interface is used to communicate with the host device, specific function(s) corresponding to second interface is/are enabled. When the first interface is used to communicate with the host device, specific function(s) and the additional first predetermined function corresponding to the first interface is/are enabled. In so doing, diverse functions instead of a single function maybe integrated and performed in one single data storage device. For example, if users are not required to exchange data wirelessly, they can plug the data storage device in a way that the wireless module is disabled to save battery power of the host device. If users are required to encrypt the data, they can plug the data storage device in a way that the encryption module is enabled to encrypt the data. In a word, the present invention facilitates usage of the data storage device and makes it much easier for users to obtain different functions they might need in one data storage device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data storage device comprising:
a memory;
a controller coupled to the memory to access data in the memory;
a first module coupled to the controller to perform a first predetermined function, wherein the first predetermined function is enabled by a command provided from the controller;
a first interface coupled to the controller for passing through a signal provided from a host device to the controller to trigger the command to the first module; and
a second interface coupled to the controller.

2. The data storage device of claim 1, wherein no signal is able to be sent through the second interface to trigger the command to the first module.

3. The data storage device of claim 1, wherein the memory comprises a flash memory.

4. The data storage device of claim 1, wherein the first module comprises a wireless module.

5. The data storage device of claim 4, wherein the wireless module comprises an antenna.

6. The data storage device of claim 1, wherein the first interface and the second interface are compatible to a same interface.

7. The data storage device of claim 6, wherein the first interface and the second interface are SD interfaces.

8. The data storage device of claim 1, wherein the first interface and the second interface are different types of interfaces.

9. The data storage device of claim 1, wherein the first interface comprises a first set of contacts, the second interface comprises a second set of contacts, and both the first set and the second set of contacts are disposed on a main substrate of the data storage device.

10. The data storage device of claim 9, wherein the first set of contacts and the second set of contacts are disposed at opposite ends of a same side of the main substrate of the data storage device .

11. The data storage device of claim 1, wherein the first module is an encryption module for encrypting data received by the first interface, and the memory has an encryption block for storing the encrypted data.

12. The data storage device of claim 11, wherein the encryption block is inaccessible to the second interface.

13. The data storage device of claim 1 further comprising a second module coupled to the controller, wherein the second module is used to perform a second predetermined function.

14. The data storage device of claim 13, wherein the second predetermined function is enabled by a second command provided from the controller, and the second command is triggered by a second signal provided from the host device to the controller.

15. The data storage device of claim 14, wherein the first module is a wireless module, the second module is an encryption module for encrypting data received by the second interface and/or the first interface, and the memory has an encryption block for storing data encrypted by the encryption module.

16. The data storage device of claim 14, wherein the first module is an encryption module for encrypting data received by the first interface, the memory has an encryption block for storing data encrypted by the encryption module, and the second module is a wireless module.

17. The data storage device of claim 16, wherein the encryption block is inaccessible to the second interface.

18. A data storage device operating method, wherein the data storage device comprises a first interface for controlling a first module, and a second interface for controlling a second module, the method comprising:
selectively connecting the data storage device to a host device through the first interface or the second interface of the data storage device;
performing a first predetermined function by the first module enabled by a first command provided from the controller when the first interface is connected to the host device; and
performing a second predetermined function by the second module enabled by a second command provided from the controller when the second interface is connected to the host device.

19. The data storage device operating method of claim 18, wherein the first interface and the second interface are compatible to a same interface.

20. The data storage device operating method of claim 19, wherein the first interface and the second interface are selected from a group comprising of Multi Media Card interface, Secure Digital interface, Serial Advanced Technology Attachment interface, and USB interface.
